(19) United States
(12) Patent Application Publication
(10) Pub. No.: US 2017/0093823 A1
(43) Pub. Date: Mar. 30, 2017

(54) Encrypting Observable Address Information

(71) Applicants: Vinodh Gopal, Westborough, MA (US); Gilbert M. Wolrich, Framingham, MA (US); Kirk S. Yap, Westborough, MA (US)

(72) Inventors: Vinodh Gopal, Westborough, MA (US); Gilbert M. Wolrich, Framingham, MA (US); Kirk S. Yap, Westborough, MA (US)

(21) Appl. No.: 14/865,751

(22) Filed: Sep. 25, 2015

(51) Int. Cl. H04L 29/06; G06F 12/14

(52) U.S. Cl. CPC H04L 63/061; G06F 12/1416; H04L 63/0442; G06F 2212/1052

(57) ABSTRACT

Address information may be secured by sharing a key between a host central processing unit subsystem and an external memory. Information about how write addresses are modified may be exchanged between said subsystem and said memory. The write addresses for the same memory location are changed each time a write accesses the address.

### BACKGROUND

Addressing patterns of computer programs can be used by attackers to determine the functionality of the program. Addressing patterns may also be used to determine storage locations of important data fields for illicit purposes.

Encrypting the observable memory addresses with a standard block-cipher algorithm or other weaker fixed scrambling circuits serves to scramble the observed addresses. However, it is insufficient to prevent an attacker with access from observing the address bus and determining the program function, data buffers and potentially the encryption key information. This is due to the consistent mapping of each encrypted address to the same physical memory address.

### BRIEF DESCRIPTION OF THE DRAWINGS

Some embodiments are described with respect to the following figures:

FIG. 1 is a schematic depiction for one embodiment; and

FIG. 2 is a flow chart for one embodiment.

### DETAILED DESCRIPTION

By encrypting the observable address information sourced by processing units and received at a memory controller, side channel observations of repeated address patterns may be frustrated. This may be used to prevent illicit access to computerized information.

At system initialization, all processing units, that have access to the memory channel and the memory channel, clear a transaction counter for the memory controller. Alternatively, on system initialization, the processing unit zeros a counter or loads the counter with a random value and then sends a command to the memory channel to synchronize that counter value at the memory unit end of the memory channel. All copies of the counter at the processing units and at the memory controller are incremented after every memory address transaction in one embodiment.

As used herein, a counter is anything that produces a unique value for encryption purposes. It need not increment or decrement. For example, the counter may use a linear feedback shift register (LFSR) to provide the unique value initialized with a common seed.

A host central processing subsystem may include one or more central processing units that address external integrated circuit memory. Examples include personal computers, game consoles, e-book readers, set top boxes and cellular telephones.

Thus the bus address (BA) driven from the processing units to the memory is equal to the real address exclusive ORed (XORed) with the encrypted counter value. The real address is the address that would have been driven on the bus to access the intended information stored in the memory if encryption was not enabled.

The memory controller determines the real address as the bus address XORed with the encrypted counter value. The observable address bus is encrypted so that accesses to the same memory locations never repeat the same value. This may be done with no changes to the memory bus protocol. For example, existing double data rate (DDR) memory protocols may be used. This may be implemented by decryption logic inside the memory unit such a dual in line memory module (DIMM). A bus protocol as described herein may be compatible with a number of memory technologies, such as LPDDR3 (low power dual data rate version 3, original release by JEDEC (Joint Electronic Device Engineering Council) JESD209-3B, August 2013 by JEDEC), LPDDR4 (LOW POWER DOUBLE DATA RATE (LPDDR) version 4, JESD209-4, originally published by JEDEC in August 2014), DDR3 (dual data rate version 3, original release by JEDEC on Jun. 27, 2007, currently on release 21), DDR4 (DDR version 4, initial specification published in September 2012 by JEDEC).

For processor chips with multiple central processing units and one or more dual in line memory module interfaces, a counter encryption logic is maintained at each dual in line memory interface. The counter at each interface is initialized at system initialization and a command is driven to the dual in line memory controller to initialize the counter at the memory unit end of the address bus. A command to synchronize the counters is useful, enabling re-synchronization without system initialization after events such as a channel error.

In some embodiments, multiple memory modules may be connected to the same host central processing unit subsystem. In such case, the host subsystem may keep track of a counter value separately incremented or decremented for each of the memory modules. Also, different keys must be used for each different memory controller to guarantee that a counter-key pair never repeats. Thus all the memory modules may be initialized at the same time in one embodiment. Then a separate counter value may be stored on the host for each of the different memory modules. Each memory module in such an embodiment only needs to know its own counter value.

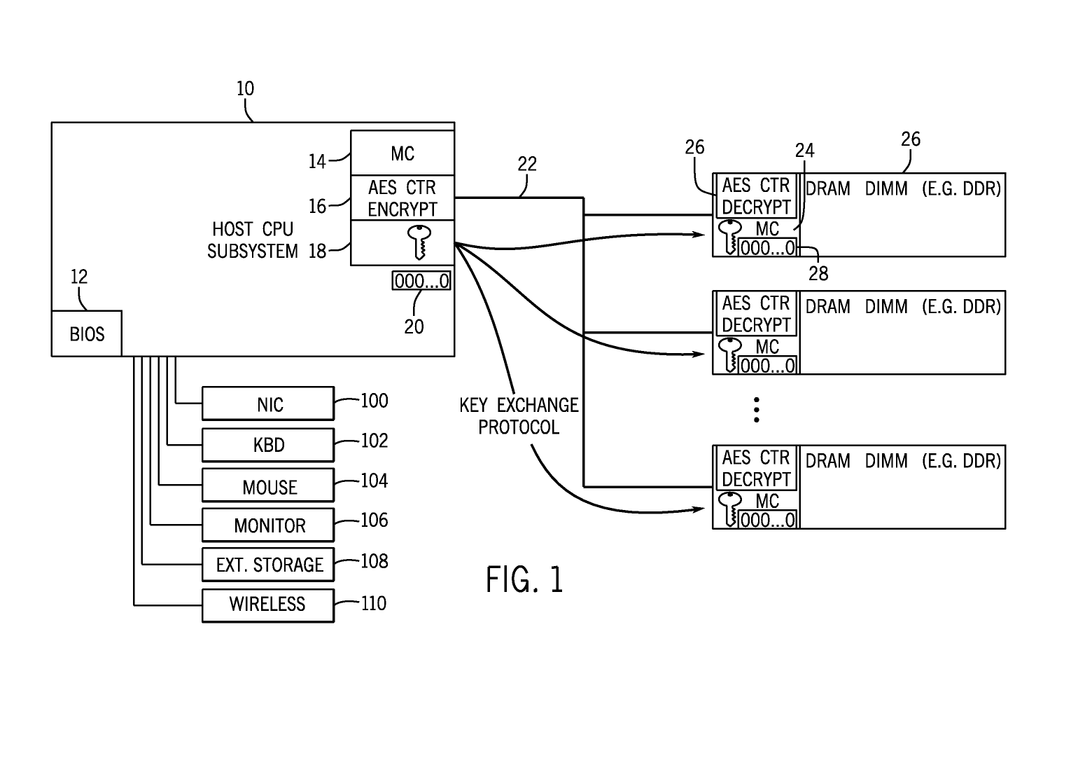

Thus referring to FIG. 1, the host subsystem 10 may include the basic input/output system (BIOS 12), microcontroller 14, and encryption device 16, such as an Advanced Encryption Standard (AES) counter (CTR) encryptor, and a key 18 based on a counter value 20. The key exchange protocol 22 sends a key to each memory controller 24 inside each memory unit 26, typically a dual inline memory module. A decryption unit 26 decrypts the encrypted memory address. A counter is continually incremented on each transaction as indicated at 28. Other types of counters and encryption may also be used. The microcontroller 14 may be a memory controller that is a standalone chip or it may be integrated with another chip or it may be part of a chipset, as examples.

The key exchange protocol maybe any useful key exchange protocol including existing protocols and extensions to existing protocols, including the Diffie-Hellman protocol, a public key infrastructure, a web of trust, a password authenticated key agreement, a quantum key exchange, a Kerberos protocol, or an IKE subprotocol from IPSEC. The key exchange protocol may use an existing addressing channel or a back channel as examples. Communication (such as key exchange) between the host and the memory controller in the memory unit can happen as follows according to one embodiment. Higher layer protocols are sometimes employed on top of a bus protocol to perform non-user functionalities. For example, a DIMM may employ a mailbox protocol on top of a double data rate (DDR) interface. This mailbox interface allows the host to communicate with the firmware of the memory controller. Some of functions performed through the mailbox interface include but are not limited to configuration, debug, system management and security related tasks. The mechanism employed is as follows. A set of mailbox registers are defined and are used to facilitate communication between the host through the DDR bus with the firmware (FW) running on the device microcontroller. They are memory mapped into address space. The mailbox registers consist of a command register, a status register, a payload registers. The Host optionally fills in possible input payload registers, writes an opcode to the command register than sets the doorbell. After the doorbell is set, the host polls the status register for completion status. When completed, if command results in data being returned, the host reads the payload register in which the data is stored

For example, in a Diffie-Hellmand key exchange, the host and the device need to exchange each other's public key. The host can send its public key with a SEND_PUBLIC_KEY command and the corresponding public key in the payload registers. Similarly, the host can retrieve the device's public key with a GET_PUBLIC_KEY, wherein the device public key can be read from the payload registers upon completion of the command.

The host may include one or more microprocessors 15 coupled to the microcontroller 14. In some embodiments, a host subsystem may be coupled to a network interface controller 100, a keyboard 102, a mouse 104, a display controller/monitor 106, an external storage 108 and a wireless interface 110, in one embodiment.

During the system initialization or boot, the host central processing unit subsystem is responsible for establishing an address encryption key and initializing the counter 20. When the system is booting, the basic input/output system 12 recognizes the memory devices 26 attached to the system 10 and enables and configures them. At this point the basic input/output system performs a key exchange with the device memory controller 24 of each memory unit 26 to establish a symmetric encryption key used for address encryption.

Any acceptable key exchange protocol can be utilized for this task. The key 18 can be used in the memory controller 14 and the host central processing unit subsystem 10 to encrypt the address prior to issuing the transaction on the bus 22, used by each of the memory controllers 24 to encrypt the address.

During a boot or power-up from the cold reset, the counters 20 and 28 are initialized to the same values between the host and the memory units 26. This can be achieved by choosing a common or constant initial value. In an alternative more flexible architecture, an initial random counter value can be established by the basic input output system and by configuring each memory unit with this initial value. This alternative method may be more desirable solution as it can be useful for synchronizing the counters in the event that the counters become out of synchronization.

Once the symmetric key has been established and the counters have been synchronized, the system is ready to process memory transactions. The actual address driven from the processing unit to the memory is the real address XORed with the encryption counter value. The memory controller determines the real address as the address bus XORed with the encryption counter value. The observable address bus is then encrypted in a manner such that accesses to the same memory locations never repeat the same value. The counters are incremented for each transaction that is processed.

While an embodiment is described where a BIOS is used to establish the encryption key and counter initialization other secure techniques may be used and they may be used at times other than initialization. For example, a secure (e.g. hardware) memory controller may be used on the host subsystem.

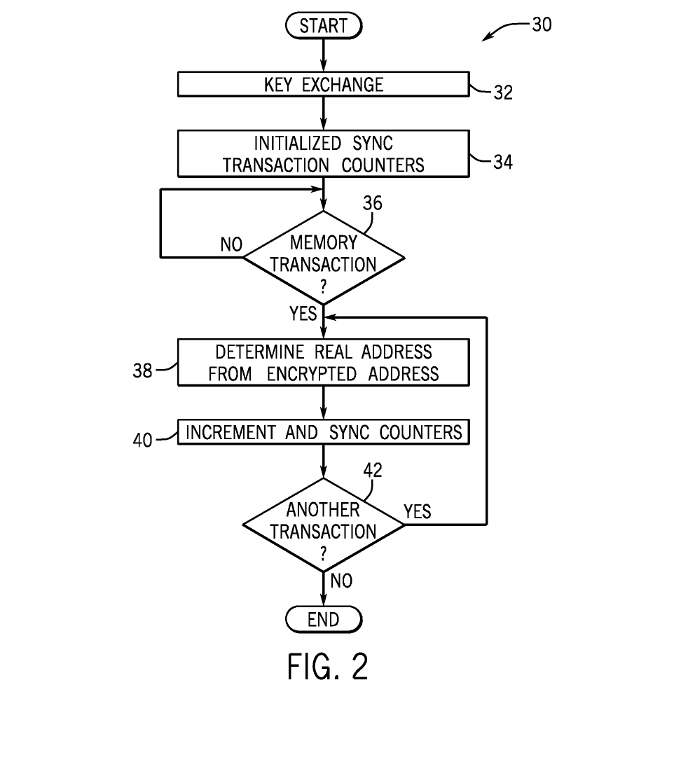

The sequence 30 shown in FIG. 2 may be implemented in software, firmware and/or hardware. In software and firmware embodiments it may be implemented by computer executed instructions stored in one or more non-transitory computer readable media such as magnetic, optical or semiconductor storages.

Thus referring to FIG. 2 the sequence 30 begins with key exchange as indicated in block 32. Then the transaction counters are initialized and synchronized across the host CPU subsystem and the memory units as indicated in block 34. When a memory transaction arises as determined in diamond 36, the real address is determined from the encrypted address using the key in the counter value as indicated in block 38. Thereafter the counter values are incremented and again synchronized as indicated at block 40. A check at diamond 42 determines whether there is another transaction and if so, the flow goes back to block 38. Otherwise the flow ends.

The memory units may be memory modules that include an integrated circuit with an on-board memory controller. Other memory modules useful in some embodiments include TransFlash memory modules, single in-line pin package memory, and single in-line memory modules (SIMM). The memory can be a non-volatile memory such as, Multi-Level Cell (MLC)/Single Level Cell (SLC)/Triple Level Cell (TLC) NAND flash memory, ferroelectric random-access memory (FeTRAM), nanowire-based non-volatile memory, three-dimensional (3D) crosspoint memory, phase change memory (PCM), memory that incorporates memristor technology, Magnetoresistive random-access memory (MRAM), Spin Transfer Torque (STT)-MRAM, and other electrically erasable programmable read only memory (EEPROM) type devices.

In some embodiments the use of a counter is advantageous since the counter changes continuously and never repeats its value. This makes it very difficult to crack this code when the initial counter value is encrypted and the count never repeats with the same key.

Of course, it is always possible that the capacity of the counter may be reached at some point. Rather than repeating the counter or restarting the counter from the beginning, in some embodiments it is advantageous to exchange a new key and a new counter start point. The count can repeat as long as it is repeated with a totally different key. This is still very difficult to crack.

Thus, in some embodiments, periodically, a new key and initial count is exchanged between the host central processing unit subsystem and the external memory. Since many counters can count quite high with relatively small storage requirements, the repeating of the transfer of the key and initial count should not happen that frequently to create any latency issue in most embodiments.

In some embodiments, the key exchange, described above, may be used to secure the exchange of the policy between the memory controller and the host central processing unit subsystem. In addition, that same key exchange protocol may be used to secure error messages past from the memory controller back to the host central processing unit subsystem where the error messages indicate that the write is not in keeping with a write policy provided by the host to the memory controller.

The following clauses and/or examples pertain to further embodiments:

One example embodiment may be a method comprising sharing a key between a host central processing unit subsystem and an external memory, exchanging information about how write addresses are modified between said subsystem and said memory, and changing write addresses for the same memory location. The method may also include synchronizing a counter on said subsystem and said memory. The method may also include utilizing a counter value from a counter on said system to encrypt a write transaction to said memory. The method may also include comparing the counter value from said subsystem to a counter value from said memory. The method may also include synchronizing during subsystem boot. The method may also include using in initial random counter value shared by counters in said subsystem and said memory. The method may also include changing a count on each write to the memory. The method may also include encrypting a bus address for a memory write as an exclusive OR of a real address and a counter value. The method may also include modifying a code used with a memory address in a way known to both the subsystem and the memory after each write to the memory. The method may also include repeatedly changing a mapping of an encrypted address to a physical memory location.

Another example embodiment may be one or more non-transitory computer readable media storing instructions executed by a processor to perform a sequence comprising sharing a key between a host central processing unit subsystem and an external memory, exchanging information about how write addresses are modified between said subsystem and said memory, and changing write addresses for the same memory location. The media may include said sequence including synchronizing a counter on said subsystem and said memory. The media may include said sequence including utilizing a counter value from a counter on said system to encrypt a write transaction to said memory. The media may include said sequence including comparing the counter value from said subsystem to a counter value from said memory. The media may include said sequence including synchronizing during subsystem boot. The media may include said sequence including using in initial random counter value shared by counters in said subsystem and said memory. The media may include said sequence including changing a count on each write to the memory. The media may include encrypting a bus address for a memory write as an exclusive OR of a real address and a counter value. The media may include said sequence including modifying a code used with a memory address in a way known to both the subsystem and the memory after each write to the memory. The media may include said sequence including repeatedly changing a mapping of an encrypted address to a physical memory location.

In another example embodiment may be a memory comprising a memory controller to share a key between a host central processing unit subsystem and the memory, exchange information about how write addresses are modified between said subsystem and said memory, and change write addresses for the same memory location, and a storage array coupled to said controller. The memory may also include said controller to synchronize a counter on said subsystem and said memory. The memory may also include said controller to utilize a counter value from a counter on said system to encrypt a write transaction to said memory. The memory may also include said controller to compare the counter value from said subsystem to a counter value from said memory. The memory may also include said controller to synchronize during subsystem boot. The memory may also include said controller to use in initial random counter value shared by counters in said subsystem and said memory. The memory may also include said controller to change a count on each write to the memory. The memory may also include said controller to encrypt a bus address for a memory write as an exclusive OR of a real address and a counter value. The memory may also include said controller to modify a code used with a memory address in a way known to both the subsystem and the memory after each write to the memory. The memory may also include said controller to repeat change a mapping of an encrypted address to a physical memory location.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
sharing a key between a host central processing unit subsystem and an external memory;
exchanging information about how write addresses are modified between said subsystem and said memory; and
changing write addresses for the same memory location.

2. The method of claim 1 including synchronizing a counter on said subsystem and said memory.

3. The method of claim 2 including utilizing a counter value from a counter on said system to encrypt a write transaction to said memory.

4. The method of claim 3 including comparing the counter value from said subsystem to a counter value from said memory.

5. The method of claim 2 including synchronizing during subsystem boot.

6. The method of claim 2 including using in initial random counter value shared by counters in said subsystem and said memory.

7. The method of claim 2 including changing a count on each write to the memory.

8. The method of claim 1 including encrypting a bus address for a memory write as an exclusive OR of a real address and a counter value.

9. The method of claim 1 including modifying a code used with a memory address in a way known to both the subsystem and the memory after each write to the memory.

10. The method of claim 1 including repeatedly changing a mapping of an encrypted address to a physical memory location.

11. One or more non-transitory computer readable media storing instructions executed by a processor to perform a sequence comprising:
sharing a key between a host central processing unit subsystem and an external memory;
exchanging information about how write addresses are modified between said subsystem and said memory; and
changing write addresses for the same memory location.

12. The media of claim 11, said sequence including synchronizing a counter on said subsystem and said memory.

13. The media of claim 12, said sequence including utilizing a counter value from a counter on said system to encrypt a write transaction to said memory.

14. The media of claim 13, said sequence including comparing the counter value from said subsystem to a counter value from said memory.

15. The media of claim 12, said sequence including synchronizing during subsystem boot.

16. The media of claim 12, said sequence including using in initial random counter value shared by counters in said subsystem and said memory.

17. The media of claim 12, said sequence including changing a count on each write to the memory.

18. The media of claim 11 including encrypting a bus address for a memory write as an exclusive OR of a real address and a counter value.

19. The media of claim 11, said sequence including modifying a code used with a memory address in a way known to both the subsystem and the memory after each write to the memory.

20. The media of claim 11, said sequence including repeatedly changing a mapping of an encrypted address to a physical memory location.

21. A apparatus comprising:
a memory controller to share a key between a host central processing unit subsystem and the memory, exchange information about how write addresses are modified between said subsystem and said memory, and change write addresses for the same memory location; and
a storage array coupled to said controller.

22. The apparatus of claim 21, said controller to synchronize a counter on said subsystem and said memory.

23. The apparatus of claim 22, said controller to utilize a counter value from a counter on said system to encrypt a write transaction to said memory.

24. The apparatus of claim 23, said controller to compare the counter value from said subsystem to a counter value from said memory.

25. The apparatus of claim 22, said controller to synchronize during subsystem boot.

26. The apparatus of claim 22, said controller to use in initial random counter value shared by counters in said subsystem and said memory.

27. The apparatus of claim 22, said controller to change a count on each write to the memory.

28. The apparatus of claim 21, said controller to encrypt a bus address for a memory write as an exclusive OR of a real address and a counter value.

29. The apparatus of claim 21, said controller to modify a code used with a memory address in a way known to both the subsystem and the memory after each write to the memory.

30. A system comprising:
a host including a microprocessor, a microcontroller coupled to said microprocessor;
a memory controller to share a key between a host central processing unit subsystem and the memory, exchange information about how write addresses are modified between said subsystem and said memory, and change write addresses for the same memory location; and
a monitor coupled to said host.
